(19) United States
(12) Patent Application Publication
(10) Pub. No.: US 2014/0037395 A1
(43) Pub. Date: Feb. 6, 2014

(54) Sintered Cemented Carbide Body, Use And Process For Producing The Cemented Carbide Body

(71) Applicant: Kennametal, Inc., Latrobe, PA (US)

(72) Inventors: Manfed Wolf, Eckersdorf (DE); Guenter Roder, Mistelgau (DE); Armin Helldorfer, Wiesenttal (DE); Dieter Schmidt, Bayreuth (DE)

(73) Assignee: Kennametal, Inc., Latrobe, PA (US)

(21) Appl. No.: 13/958,222

(22) Filed: Aug. 2, 2013

(30) Foreign Application Priority Data
Aug. 6, 2012 (DE) 10 2012 015 565.4

(51) Int. Cl. C22C 29/06; B23C 5/20

(52) U.S. Cl. CPC C22C 29/06; B23C 5/20
USPC 409/131; 419/14; 75/236

(57) ABSTRACT

A sintered cemented carbide body comprises tungsten carbide as hard material and a metallic binder which contains cobalt (Co), chromium (Cr) and copper (Cu). The cobalt is present in a proportion of 7.0 to 14.0% by weight in the sintered cemented carbide. The copper proportion is from 0.05 to 3.8% by weight and the chromium proportion is from 0.2 to 1.9% by weight, in each case based on the overall weight of the sintered cemented carbide body.

The cemented carbide body is advantageously used for cutting titanium and titanium alloys, cast iron and steel.

### RELATED APPLICATION DATA

The present application claims priority pursuant to 35 U.S.C. §119(b) to German Patent Application Number 102012015565.4 filed Aug. 6, 2012 which is hereby incorporated by reference in its entirety.

### FIELD

The invention relates to sintered cemented carbide bodies comprising tungsten carbide as the hard material phase and a metallic binder which contains cobalt, chromium and copper.

### BACKGROUND

In the case of cemented carbides for cutting purposes, the quality of a cemented carbide grade is determined quite considerably by its high-temperature properties. The hardness of the cemented carbides usually decreases greatly with an increasing temperature, and at the same time the deformation behavior of cutting inserts or other bodies produced from the cemented carbide likewise changes drastically.

The mechanical properties of the sintered cemented carbides are also influenced by the way in which they are produced by powder metallurgy. Grain growth which is unavoidable during sintering of the corresponding green compacts has a negative effect on the transverse rupture strength and/or the hardness of the sintered cemented carbide. Therefore, specific carbides are admixed to the starting powder mixture as grain growth inhibitors. The most frequently used grain growth inhibitors are tantalum carbide, chromium carbide and vanadium carbide, where tantalum carbide is generally used as a (Ta, Nb)C mixed carbide owing to the natural association of the metals tantalum and niobium and for reasons of cost.

During sintering of the cemented carbide powders, both tungsten from the tungsten carbide and the metals of the grain growth inhibitors diffuse into the binder phase and are dissolved therein to form a solid solution. Since the solubility of these metals in the binder metal is greater at a relatively high temperature than at room temperature, the excess quantity which is no longer soluble at room temperature can be precipitated out of the binder phase again.

In certain applications, such as the milling of metals and metal alloys, the cutting operation is continually interrupted, with the cutting tool being exposed to a continuous alternation between thermal expansion and contraction by heating during the cutting operation and cooling during the interruption phase. This fluctuating temperature loading produces thermal cracks, which can be a cause of the nonuniform wear of the cutting tool.

Sintered cemented carbide bodies based on tungsten carbide having a cobalt-chromium binder phase, for example WC-11.5% Co-0.5% Cr, already exhibit good high-temperature properties and a good resistance to thermal shocks. These cemented carbides are therefore used with preference as cutting tools for milling steel or cast iron.

DD 267 063 A1 describes sintered cemented carbide bodies, which are used as cutting inserts for cutting wood and plastics. The proportion of cobalt in these cutting inserts is approximately 4 to 6% by weight. In addition, 0.5 to 1% by weight chromium and 0.5 to 1.5% by weight copper are present, in each case based on the overall composition of the sintered cemented carbide alloy. Compared to a comparative alloy without copper, and given the same hardness, the copper addition should give rise to a higher transverse rupture strength and an improved thermal conductivity.

However, the extremely low magnetic saturation of the known copper-containing cemented carbides suggests the presence of a considerable proportion of substoichiometric brittle phases in the binder alloy. Owing to the lack of toughness, the cutting inserts described in DD 267 063 A1 are therefore not suitable for machining metals and metal alloys.

### SUMMARY

The invention is based on the object of providing sintered cemented carbide grades which have an improved wear behavior in a cutting test and which can be used for metal cutting operations of all kinds, in particular for milling metals and metal alloys, and for producing cutting inserts and other cutting tools.

This object is achieved according to the invention by a sintered cemented carbide body having the features of claim 1.

### BRIEF DESCRIPTION OF THE DRAWINGS

FIG. 1 shows a graphical illustration of the thermal conductivity between 20 and 600° C. of a cemented carbide according to the invention compared to a known chromium-containing cemented carbide grade;

FIG. 2 shows a graphical illustration of the coefficient of thermal expansion depending on the temperature of a cemented carbide according to the invention compared to a known chromium-containing cemented carbide grade; and

FIG. 3 shows a content triangle of cemented carbides according to the invention, indicating the solubility limits of Cr and Cu at room temperature in the three-phase system Co—Cu—Cr.

### DETAILED DESCRIPTION

The sintered cemented carbide body according to the invention comprises tungsten carbide as hard material and a metallic binder which contains cobalt (Co), chromium (Cr) and copper (Cu). The cobalt is present in a proportion of 7.0 to 14.0% by weight, preferably of 9.0 to 12.0% by weight, in the sintered cemented carbide. The copper proportion is from 0.05 to 3.8% by weight, preferably 0.2 to 3.6% by weight, and the chromium proportion is from 0.2 to 1.9% by weight, preferably 0.4 to 1.9% by weight, in particular 0.8 to 1.9% by weight, in each case based on the overall weight of the sintered cemented carbide body.

The invention has succeeded in providing sintered cemented carbides which have a good resistance to thermal shocks and which are suitable in particular for applications with interrupted cutting operations, for example the milling of steel, cast iron and other metal alloys, in particular titanium and titanium alloys. It has surprisingly been found that the copper addition leads to a significantly improved service life of the tools in a cutting test over a wide range of applications. It is assumed that the copper addition counteracts the occurrence of thermal cracks during the cutting operation, even though the cemented carbide bodies according to the invention have a lower thermal conductivity than comparative compositions without a copper addition. The hardness of the cemented carbide bodies according to the invention is not adversely affected by the copper addition and can be set, for example by using a fine-grained tungsten carbide, in such a way that the hardness of the known chromium-containing cemented carbides is obtained.

Preferred embodiments of the invention are indicated in the dependent claims and can be combined optionally and independently of one another.

To produce the cemented carbide body, preferably in the form of a cutting insert, fine-particle pulverulent starting materials, which contain WC as the hard material, Co and Cu as the metallic binder and compounds of Cr, in particular Cr₃C₂, and if appropriate compounds of other elements such as Ti, Zr, Hf, Ta, Nb, V and/or Mo, are ground in a ball mill or an attritor, if appropriate with the addition of carbon or tungsten and common grinding and/or pressing aids, pressed to form a green compact of a desired form and then sintered and, if appropriate, provided with a hard, wear-resistant coating.

The quantity of carbon and/or tungsten which is to be added to the starting powder mixture is known and familiar to a person skilled in the art. The quantities to be added are to be chosen in such a way that neither a brittle η phase nor free carbon forms.

Owing to the low melting point of copper, a copper loss can occur during the sintering of the copper-containing starting powder mixtures. The sintered cemented carbides according to the invention can therefore have a copper gradient with a copper content which decreases from the core of the cemented carbide body toward the outer shell.

The hard material of the cemented carbide body according to the invention preferably consists of tungsten carbide, excluding unavoidable impurities.

The mean grain size of the WC powder used for producing the sintered cemented carbide preferably lies in the range of approximately 0.1 to 8.0 μm, preferably between approximately 0.9 and 5.0 μm.

As a substitute for the tungsten carbide, the cemented carbide body can contain at least one further hard material in proportions of up to 5% by mass, preferably up to 3% by mass, and particularly preferably of 0.4 to 2.5% by mass, this being selected from the carbides, nitrides, carbonitrides, including the mixtures and solid solutions thereof, of the metals titanium, zirconium, hafnium, niobium, tantalum, vanadium and molybdenum.

Preferred further hard materials are TaC, TaNbC and ZrNbC and also TiC.

To produce the cemented carbide bodies according to the invention, it is also possible to advantageously use those commercial WC grades which have already been doped with chromium carbide (Cr₃C₂).

The metallic binder is preferably present in the sintered cemented carbide body in a proportion of 19.0 to 23.0% by volume.

According to a preferred embodiment, the sintered cemented carbide body has a cobalt proportion of 9.0 to 12% by weight.

In this embodiment, the copper proportion in the sintered cemented carbide body is from 1.7% to 24.5%, based on the overall weight of the components Co, Cu and Cr of the binder.

The chromium proportion in the sintered cemented carbide is preferably from 6.0% to 14.4%, based on the overall weight of the components Co, Cu and Cr of the binder.

Within said ranges of the proportions of Co, Cr and Cu, it is possible to produce sintered cemented carbides having an optimum combination of hardness and toughness and also transverse rupture strength for the cutting of metallic materials with interrupted cutting operations.

According to a further preferred embodiment, the copper proportion in the sintered cemented carbide body lies below the solubility limit of Cu at room temperature in the 3-phase system Co—Cu—Cr.

The sintered cemented carbide body preferably has a copper proportion in the cemented carbide body of 0.2 to 0.8% by weight.

The copper proportion preferably lies in the range of 1.7 to 6.10, based on the overall weight of the metallic binder.

Cutting tools made of these cemented carbides are preferably used for cutting metals and metal alloys, preferably titanium and titanium alloys.

According to a further embodiment of the invention, the sintered cemented carbide body comprises a metallic binder having a copper proportion which lies above the solubility limit of Cu in the 3-phase system Co—Cu—Cr.

The copper proportion in the sintered cemented carbide body preferably lies in the range of 1.2 to 3.6% by weight, based on the overall weight of the cemented carbide body.

The copper proportion is preferably from 8.4 to 24.5%, based on the overall weight of the components Co, Cu and Cr of the binder.

The cemented carbide grades having a high copper proportion are suitable in particular for milling cast iron and steel, and preferably for applications without coolant.

According to a further embodiment of the sintered cemented carbide body, the chromium proportion in the cemented carbide body lies below the solubility limit of Cr in the 3-phase system Co—Cu—Cr.

In this embodiment, the chromium proportion preferably lies in the range of 0.4 to 0.8% by weight, based on the overall weight of the cemented carbide body.

The chromium proportion is preferably from 6.0 to 8.0%, based on the overall weight of the components Co, Cu and Cr of the binder.

According to a further embodiment, the Cr proportion in the sintered cemented carbide body lies above the solubility limit of Cr in the 3-phase system Co—Cu—Cr.

In this embodiment, the chromium proportion of the cemented carbide body preferably lies in the range of 1.4 to 1.9% by weight, based on the overall weight of the cemented carbide body.

The chromium proportion is preferably from 9.7 to 14.4% by weight, based on the overall weight of the components Co, Cu and Cr of the metallic binder.

If the proportions of chromium and/or copper lie above the respective solubility limit, it is to be assumed that the metallic binder has, in addition to the Co—Cu—Cr solid solution phase, a second or third phase of the excess metal in each case.

The sintered cemented carbide body according to the invention is preferably used as a cutting tool and has at least one cutting edge, which is formed at the point where a flank and a rake face meet. The cutting tool can be present in the form of a drill, bit, lathe tool, milling cutter or a part of these tools, in the form of a cutting insert or an indexable insert.

The sintered cemented carbide body is preferably provided with at least one wear-resistant coating applied to the body.

The wear-resistant coating can comprise one or more layers and can be applied to the body by physical or chemical vapor deposition (CVD or PVD). The layers, independently of one another, commonly consist of carbides, carbonitrides, carboxynitrides or nitrides of metals from groups 4, 5 and 6 of the Periodic Table of the Elements, in particular TiC, TiN and/or TiCN, and also aluminum oxide, TiAl and TiAlN.

The wear-resistant coating preferably comprises at least one coating of TiCN applied in a CVD process and an aluminum oxide layer applied to the TiCN layer. Further preference is given to coatings having a PVD layer of TiAlN.

Further embodiments of the invention are specified in the following examples, which however are not to be understood as having a limiting effect.

For the production of the sintered cemented carbides according to the invention, in all the examples which follow, the pulverulent raw materials Co, Cu and Cr₃C₂ and as remainder WC and also optionally W and/or C were wet-ground in an attritor or a ball mill and then dried. Green compacts of tools having the geometry indicated in each case were then pressed from the ground and dried powder mixtures. The green compacts were then sintered at temperatures of between 1400 and approximately 1450° C. under argon until the maximum density was reached.

After the sintered cemented carbide shaped bodies had cooled to room temperature, the high-temperature properties of the sintered cemented carbides obtained were determined with the aid of common cutting tests.

In addition, the density to ISO 3369, the Vickers hardness (HV50) to ISO 3878, the coercive force (Hc) to ISO 3326, the magnetic saturation (MS), the Palmqvist toughness (K_{1c}) to ISO 28079 and the transverse rupture strength (TRS) to ISO 3327 type B of cemented carbide grades according to the invention and of some known cemented carbide grades were determined and compared with one another. The magnetic saturation was measured on a Sigmameter D-5001 from Setaram.

Table 1 below indicates the composition of the binder proportion determined in the sintered cemented carbides by means of X-ray fluorescence analysis and also the mean grain size of the tungsten carbide of the investigated cemented carbide grades as used in the starting powder mixture. The indication “mass500” denotes a highly carburized tungsten carbide from H. C. Starck having a grain size of approximately 4.7 to 5.8 μm.

TABLE 1

| Mix- | | | | | % by | Proportion in the | | |
|---|---|---|---|---|---|---|---|---|
| ture | | % by weight | | | volume | binder [% by weight] | | |
| No. | WC [μm] | Co | Cu | Cr | Binder | Co | Cu | Cr |
| V-1 | 5.0 + 2.5 | 11.5 | | 0.43 | 19.65 | 96.4 | 0.0 | 3.6 |
| | (50/50) | | | | | | | |
| V-2 | 5.0 + 2.5 | 10.74 | | 0.92 | 19.46 | 92.1 | 0.0 | 7.9 |
| | (50/50) | | | | | | | |
| E-1 | 5.0 + 2.5 | 10.5 | 1 | 0.43 | 19.64 | 88.0 | 8.4 | 3.6 |
| | (50/50) | | | | | | | |
| E-2 | 5.0 + 2.5 | 9.5 | 2 | 0.43 | 19.64 | 79.6 | 16.8 | 3.6 |
| | (50/50) | | | | | | | |
| E-3 | 5.0 + 2.5 | 10.45 | 1.15 | 1.0 | 21.01 | 83.0 | 9.1 | 7.9 |
| | (50/50) | | | | | | | |
| E-4 | 5.0 + 2.5 | 10.4 | 0.5 | 0.9 | 19.44 | 87.9 | 4.3 | 7.8 |
| | (50/50) | | | | | | | |
| E-5 | 2.5 | 10.2 | 0.4 | 0.9 | 18.99 | 88.2 | 3.8 | 8.0 |
| E-6 | mass500 | 10.2 | 0.5 | 0.9 | 19.16 | 87.8 | 4.2 | 8.0 |
| E-7 | mass500 | 10.9 | 0.2 | 0.9 | 19.7 | 90.8 | 1.7 | 7.5 |
| E-8 | mass500 | 10.9 | 0.4 | 0.9 | 20 | 89.3 | 3.3 | 7.4 |
| E-9 | mass500 | 10.7 | 0.7 | 0.9 | 20.1 | 87.0 | 5.7 | 7.3 |
| E-10 | 5.0 + 2.5 | 10.3 | 1.2 | 0.8 | 20.1 | 83.7 | 9.8 | 6.5 |
| | (50/50) | | | | | | | |
| E-11 | 2.5 + 0.9 | 9.9 | 2.6 | 0.8 | 21.6 | 74.4 | 19.5 | 6.0 |
| | (75/25) | | | | | | | |
| E-12 | mass500 | 10.6 | 0.7 | 1.4 | 20.2 | 83.5 | 5.5 | 11.0 |
| E-13 | 2.5 | 9.7 | 2.4 | 1.3 | 21.3 | 72.4 | 17.9 | 9.7 |
| E-14 | mass500 | 10.5 | 0.8 | 1.9 | 20.4 | 79.5 | 6.1 | 14.4 |
| E-15 | 2.5 + 0.9 | 9.4 | 3.6 | 1.7 | 22.5 | 63.9 | 24.5 | 11.6 |
| | (75/25) | | | | | | | |

The cemented carbide grades E-1 to E-15 are in accordance with the invention, whereas the grades V-1 and V-2 are known cemented carbide grades or cemented carbide grades not in accordance with the invention. Table 2 indicates the physical and mechanical properties measured for each of the investigated cemented carbide grades.

TABLE 2

| | | MS | | | K_{1C} | |
|---|---|---|---|---|---|---|
| Mixture | Density | 0.1 x | Hc | Hardness | MPa | TRS |
| No. | g/cm³ | μTm³/kg | Oe | HV50 | m^{-1/2} | N/mm² |
| V-1 | 14.33 | 199 | 138 | 1308 | 13.84 | 3332 ± 102 |
| V-2 | 14.27 | 157 | 173 | 1440 | 12.10 | N/S |
| E-1 | N/S | 187 | 170 | 1354 | 12.35 | 3639 ± 108 |
| E-2 | N/S | 171 | 176 | 1371 | 11.81 | 3335 ± 158 |
| E-3 | N/S | 171 | 170 | 1384 | 12.32 | 3268 ± 115 |
| E-4 | 14.27 | 147 | 187 | 1385 | 12.01 | N/S |
| E-5 | 14.26 | 150 | 192 | 1419 | 11.68 | N/S |
| E-6 | 14.29 | 143 | 167 | 1338 | 12.72 | N/S |
| E-7 | 14.22 | 158 | 153 | 1400 | 14.40 | N/S |
| E-8 | 14.20 | 156 | 157 | 1376 | 14.57 | N/S |
| E-9 | 14.13 | 152 | 161 | 1345 | 13.79 | N/S |
| E-10 | 14.19 | 145 | 181 | 1360 | 12.84 | N/S |
| E-11 | 14.10 | 135 | 200 | 1395 | 11.75 | N/S |
| E-12 | 14.03 | 147 | 179 | 1388 | 12.38 | N/S |
| E-13 | 14.04 | 123 | 199 | 1378 | 12.07 | N/S |
| E-14 | 13.99 | 144 | 182 | 1397 | 12.16 | N/S |
| E-15 | 13.86 | 118 | 197 | 1350 | 11.54 | N/S |

### Example 1

Cutting inserts for a face milling cutter having the geometry SEKN1203AFTN were produced from the cemented carbide grades V-1, E-1, E-2 and E-3 by pressure sintering at temperatures of between 1400° C. and 1435° C. and with a holding time of 5 to 60 minutes. The tungsten carbide used as the starting material was a powder mixture having mean grain sizes of 5.0 μm (50%) and 2.5 μm (50%). The grain size can be determined in a known manner using a Fisher Subsieve Sizer FSSS to ASTM B 330.

The cutting inserts were provided with a TiAlN coating having a thickness of approximately 3.5 μm by a PVD process.

The cutting inserts produced from the cemented carbide grades described above were subjected to a cutting test using a face milling cutter with a tool holder of the type 4.00605R551, which had a diameter of 63 mm and a width of cut of 50 mm and a setting angle of 45°. The milling cutter was operated synchronously. Each tool holder was equipped with one of the cutting inserts to be investigated. The cutting test was carried out under the following conditions:
Material of the workpiece to be cut: steel 1.1730 (C45)
Cutting speed: 350 m/min
Feed rate: 0.2 mm/rev
Depth of cut (DOC): 2.0 mm
Coolant: wet cooling

The length of cut obtained until a maximum wear mark width on the flank of 0.4 mm was reached is indicated in table 3 below.

TABLE 3

| | Wear of the flank | |
|---|---|---|
| | according to length | |
| | of cut [m] | |
| Cemented carbide | (Mean value from two | Change in the service |
| grade | passes) | life |
| V-1 | 2.0 | 100% |
| E-1 | 2.0 | 100% |
| E-2 | 2.6 | 130% |
| E-3 | 3.0 | 150% |

The results show that the copper-containing cemented carbide grades provide an at least equal (E-1) or even improved cutting performance (E-2 and E-3) compared to the commercially available chromium-containing cemented carbide grade (V-1). It can be seen from comparing the cemented carbides E-1 and E-2 that the service life of the tool is improved, given the same chromium proportion, with an increasing copper proportion. An increase in the chromium proportion given a relatively low copper proportion likewise leads to an improvement in the service life of the tool.

### Example 2

Further cutting inserts having the geometry SEKN1203AFTN produced from the cemented carbide grades V-1, E-1, E-2 and E-3 as per example 1 were subjected to a cutting test on a steel, 1.8159. For the cutting test, use was made of the face milling cutter described in example 1 in synchronous operation. The test conditions are indicated in table 4a below:

TABLE 4a

| | |
|---|---|
| Material | Steel 1.8159 (51CrV4) |

| | | | |
|---|---|---|---|
| Cutting speed | 200 mm/min | Depth of cut | 2.0 mm |
| Feed rate | 0.2 mm/rev | Width of cut | 50 mm |
| Coolant | Yes | Path length | 0.4 m |

| | |
|---|---|
| Wear criteria | Maximum wear >0.4 mm |

The length of cut obtained until the maximum wear mark width on the flank of 0.4 mm was reached is indicated in table 4b below.

TABLE 4b

| | Length of cut [m] | |
|---|---|---|
| Cemented carbide | (Mean value from two | Change in the service |
| grade | passes) | life |
| V-1 | 1.28 | 100% |
| E-1 | 1.1 | 86% |
| E-2 | 0.96 | 75% |
| E-3 | 2 | 156% |

The results of the cutting tests likewise show that, by adding copper to chromium-containing tungsten carbide cemented carbides, the cutting performance of the sintered cemented carbides under demanding conditions with a high fluctuating temperature loading can be improved considerably, or at least the cutting performance of commercially available cemented carbides is reached.

The physical properties of the chromium-containing and copper-containing cemented carbides E-1, E-2 and E-3, such as hardness (HV50), fracture toughness (K_{1c}) and transverse rupture strength (TRS), are also comparable with the properties of the commercially available grade V-1.

Cemented carbides produced from copper-containing powder mixtures without a chromium addition appear, by contrast, to show no advantages in the investigated applications.

### Example 3

Cutting inserts for a face milling cutter having the geometry SEKN1203AFTN were produced from the cemented carbide grades V-1 and V-2 and also E-4, E-5 and E-6 and provided with a wear-resistant TiAlN PVD coating having a thickness of approximately 3.5 μm. A cutting insert having the composition indicated for the alloy V-1 can be obtained from Kennametal Inc., Latrobe, Pa., USA under the trade name KC725M.

The cemented carbide grades were produced by sintering the powder mixtures of corresponding composition at temperatures of between 1400 and 1435° C. under argon and with holding times of 5 to 30 minutes. The sintering temperature was preferably approximately 1420° C. Under these conditions, there was a copper loss during the sintering, which can be taken into consideration in the formulation of the starting powder mixtures by a somewhat higher copper addition. The thus produced cemented carbide grades according to the invention had a copper gradient with a copper proportion which decreases from the core of the cemented carbide body in the direction toward the outer shell.

The cutting inserts obtained in this way were tested on various workpieces in the face milling cutter described in the preceding examples under the conditions indicated in table 5a below. For each cutting insert, the length of cut obtained until a maximum wear mark width on the flank of 0.25 mm was reached was measured and correlated with the length of cut obtained with the cutting insert made of the alloy V-1. The changes to the tool service lives in percent are indicated in table 5b.

TABLE 5a

| Material | 50CrV4 | 50CrV4 | C45 | C45 | GGG60 | GGG60 |
|---|---|---|---|---|---|---|
| Cutting speed | 200 | 300 | 300 | 300 | 180 | 280 |
| [m/min] | | | | | | |
| Feed rate [mm/rev] | 0.2 | 0.2 | 0.2 | 0.2 | 0.3 | 0.2 |
| Coolant | Yes | No | Yes | No | Yes | Yes |

TABLE 5b

| | |
|---|---|
| Cemented | |
| carbide | Change in the service life |

| | | | | | | |
|---|---|---|---|---|---|---|
| V-1 | 100% | 100% | 100% | 100% | 100% | 100% |
| V-2 | 73 | 77 | 70 | 117 | 113 | 125 |
| E-4 | 61 | 240 | 70 | 161 | 138 | 150 |
| E-5 | 105 | 200 | 110 | 100 | 138 | 150 |
| E-6 | 80 | 159 | 50 | 144 | 100 | 150 |

A comparison of the physical properties of the cemented carbides V-2 and E-4 as indicated in table 2 shows that a copper addition, with the same chromium proportion, slightly reduces the hardness of the cemented carbide. On average, slightly improved results arise for the copper-containing cemented carbide E-4 in the cutting test. Supplementary tests were able to show that a further increase in the copper proportion by approximately 1% by weight brings about a decrease in the hardness (HV50) by approximately 140 points.

The decrease in the hardness which is caused by the copper addition can in part be compensated for by a higher chromium proportion or by using a fine-grained tungsten carbide. The sintered cemented carbides V-1 and E-6 therefore exhibit a substantially identical hardness with the same binder volume. The copper-containing cemented carbide E-6 has a considerably improved performance in the cutting test under the conditions indicated in table 5 above. A comparison of the sintered cemented carbides V-2 and E-5 shows the same result.

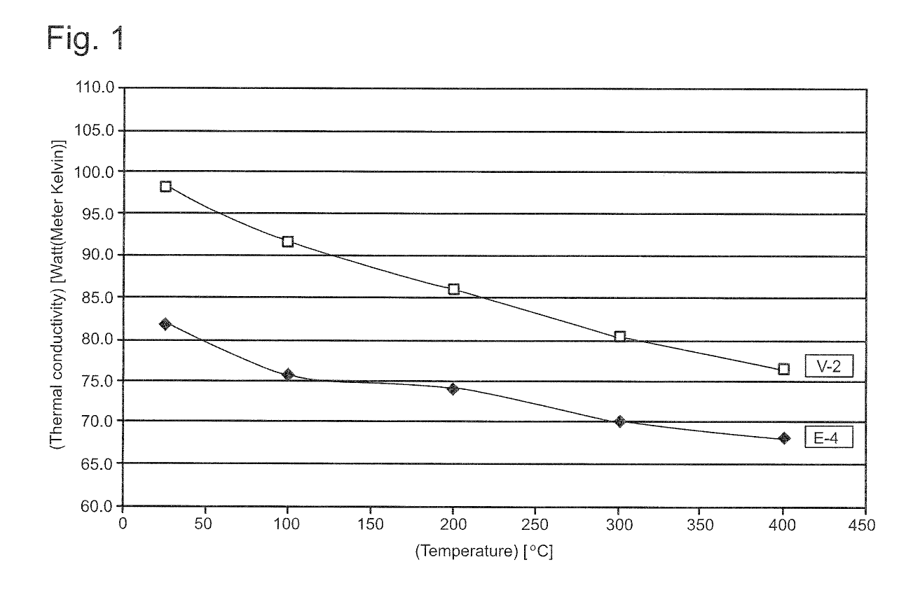

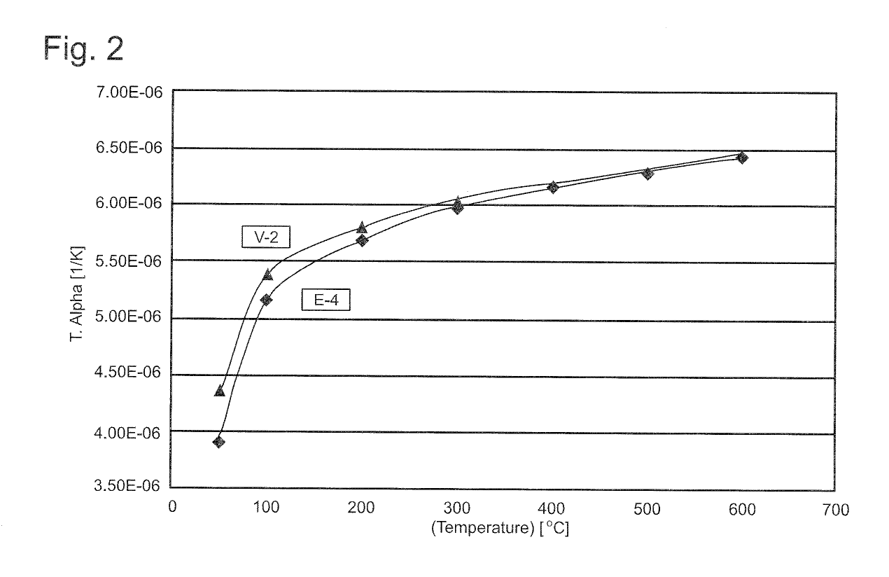

The sintered cemented carbides V-1 and E-4 were investigated with respect to the thermal conductivity at 20 to 400° C. and the coefficient of thermal expansion. The thus obtained results are compiled in FIGS. 1 and 2.

It has surprisingly been found that the sintered cemented carbide E-4 has a lower thermal conductivity than the alloy V-1 known from the prior art. The coefficient of thermal expansion of the cemented carbide E-4 is, by contrast, only insignificantly lower than the coefficient of thermal expansion of the comparative alloy.

### Example 4

Cutting inserts for a face milling cutter having the geometry SEKN1203AFTN were produced from the cemented carbide grades V-1 and also E-7 to E-15 as per the process indicated in example 3 and provided with a TiAlN PVD coating having a thickness of approximately 3.5 μm. The mean grain size of the tungsten carbide in the raw material was selected in such a way that sintered cemented carbides having a substantially identical hardness to the comparative composition were obtained.

The copper proportion in the sintered cemented carbide as determined by means of X-ray fluorescence analysis varied from 0.2 to 3.6% by weight, and the chromium proportion was in the range of 0.8 to 1.9% by weight.

The cobalt proportion was set in such a way that the comparative composition V-1 and the cemented carbides according to the invention had a substantially identical binder volume. The cobalt proportion in the investigated powder mixtures was in the range of approximately 9.4 to 11.0% by weight.

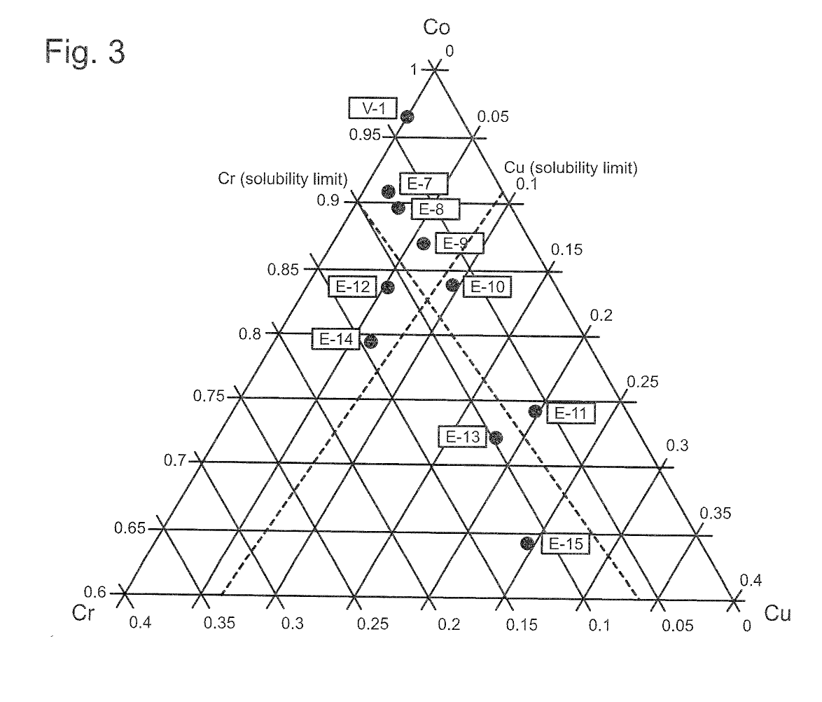

A content triangle showing the proportions of Co, Cu and Cr in the sintered cemented carbide is shown in FIG. 3. It can be gathered therefrom that the chromium proportion in the cemented carbides E-12, E-13, E-14 and E-15 lies above the solubility limit of chromium at room temperature in the three-phase system Co—Cr—Cu. The copper proportion in the cemented carbides E-10, E-11, E-13 and E-15 lies above the solubility limit of copper at room temperature in the three-phase system Co—Cr—Cu.

The cutting inserts produced from the sintered cemented carbides were tested on various workpieces in a face milling cutter in synchronous operation under the conditions indicated in tables 6 to 8 below.

TABLE 6

Material: TiAlV4

| | |
|---|---|
| Cutting speed: 65 m/min | Depth of cut: 1.5 mm |
| Feed rate: 0.14 mm/rev | Width of cut: 50 mm |
| Coolant: Yes | Path length: 0.2 m = 4.2 min |

Wear criteria: Maximum wear >0.25 mm

TABLE 7

Material: GGG60 (nodular cast iron)

| | |
|---|---|
| Cutting speed: 180 m/min | Depth of cut: 2.0 mm |
| Feed rate: 0.2 mm/rev | Width of cut: 50 mm |
| Coolant: Yes | Path length: 0.4 m = 2.2 min |

Wear criteria: Maximum wear >0.25 mm

TABLE 8
Material: 50CrV4 (steel no. 1.8159)

| | |
|---|---|
| Cutting speed: 280 m/min | Depth of cut: 2.0 mm |
| From 10 m length of cut: 300 m/min | |
| Feed rate: 0.2 mm/rev | Width of cut: 50 mm |
| Coolant: No | Path length: 0.4 m = 1.5 min |

Wear criteria: Maximum wear >0.25 mm

For each cutting insert, the length of cut obtained until the maximum wear mark width on the flank was reached was measured and correlated with the length of cut obtained with the cutting insert made of the cemented carbide grade V-1.

The results of the cutting tests are indicated in table 9 below.

TABLE 9

| Material/cemented | Change in the service life | | | |
|---|---|---|---|---|
| carbide grade | TiAl6V4 | GGG60 | 50CrV4 | Mean value |
| V-1 | 100% | 100% | 100% | 100% |
| E-7 | 127% | 75% | 75% | 92% |
| E-8 | 127% | 110% | 104% | 114% |
| E-9 | 100% | 90% | 50% | 80% |
| E-10 | 105% | 120% | 196% | 140% |
| E-11 | 85% | 165% | 311% | 187% |
| E-12 | 48% | 135% | 75% | 86% |
| E-13 | 79% | 215% | 357% | 217% |
| E-14 | 66% | 120% | 282% | 156% |
| E-15 | 36% | 110% | 282% | 143% |

The results of the cutting tests on Ti6Al4V show that the cemented carbide grades according to the invention E-7, E-8, E-9 and E-10, with a copper proportion below the solubility limit of copper at room temperature in the three-phase system Co—Cu—Cr, in particular with a copper proportion of 0.2 to approximately 1.2% by weight in the cemented carbide, give a comparable or better cutting performance than the comparative composition V-1, without copper.

A decrease in the Palmqvist toughness (K_{1c}) can be observed with an increasing copper proportion.

If the proportions of chromium and/or copper lie above the respective solubility limit, it was not possible by contrast to obtain an improved cutting performance on Ti6Al4V under the tested conditions.

When cutting nodular cast iron GGG60, virtually all copper-containing cemented carbide grades show an improvement compared to the comparative composition V-1. The best results are achieved with cutting tools made of cemented carbides which have a high copper proportion of approximately 0.7 to 3.6% by weight (E-10 to E-15), preferably 1.2 to approximately 2.6% by weight (E-10, E-11 and E-13).

The best resistance to fluctuating temperatures is achieved by cemented carbide grades having a copper proportion of approximately 2.4 to 2.6% by weight in the sintered cemented carbide, even if the chromium content is relatively low and lies in the range of approximately 0.8 to 1.3% by weight (E-11 and E-13).

In the case of relatively low copper proportions of approximately 0.7 to 1.0% by weight, the cutting performance on cast iron can be improved by a higher chromium content of 1.4 to 1.9% by weight (E-12 and E-14).

The cutting tests on steel also show that virtually all investigated copper-containing cemented carbide grades provide a cutting performance which is comparable to or better than that of the sintered cemented carbides produced from the comparative composition V-1. In particular, the cemented carbide grades having a copper content of above approximately 0.8% by weight, in particular 0.8 to 3.6% by weight (E-10, E-11, E-13, E-14, E-15), particularly preferably 2.4 to 3.6% by weight copper (E-11, E-13 and E-15), provide a considerably improved tool service life under the tested conditions.

The resistance to thermal shocks appears to increase with the copper proportion in the cemented carbide given a constant chromium content. The best results are therefore achieved with cemented carbide grades which have a copper content of 2.4 to 3.6% by weight. The chromium proportion in these cemented carbide grades was approximately 0.8 to 1.9% by weight (E-11, E-13 and E-15).

1. A sintered cemented carbide body comprising tungsten carbide and a metallic binder which contains cobalt, chromium and copper, wherein cobalt is present in a proportion of 7.0 to 14.0% by weight, copper is present in a proportion of 0.05 to 3.8% by weight and chromium is present in a proportion of 0.2 to 1.9% by weight, in each case based on the overall weight of the sintered cemented carbide body.

2. The cemented carbide body of claim 1, wherein the cobalt proportion is from 9.0 to 12.0% by weight.

3. The cemented carbide body of claim 1, wherein the chromium proportion is from 0.4 to 1.9% by weight.

4. The cemented carbide body of claim 1, wherein the copper proportion is from 0.2 to 3.6% by weight.

5. The cemented carbide body of claim 1, wherein the copper proportion in the metallic binder is from 1.7 to 28.8% by weight, based on the nominal overall weight of the components Co, Cu and Cr of the binder.

6. The cemented carbide body of claim 1, wherein the chromium proportion in the metallic binder is 6.0% to 14.4% by weight, based on the nominal overall weight of the components Co, Cu and Cr of the binder.

7. The cemented carbide body of claim 1, wherein the binder is present in a proportion of 19.0 to 23.0% by volume.

8. The cemented carbide body of claim 1, wherein the copper proportion in the cemented carbide body lies below the solubility limit of Cu in the 3-phase system Co—Cu—Cr.

9. The cemented carbide body of claim 8, wherein the copper proportion in the cemented carbide body lies in the range of 0.2 to 0.8% by weight.

10. The cemented carbide body of claim 8, wherein the copper proportion in the metallic binder lies in the range of 1.7 to 6.1%, based on the nominal overall weight of the components Co, Cu and Cr of the binder.

11. The cemented carbide body of claim 1, wherein the copper proportion in the cemented carbide body lies above the solubility limit of Cu in the 3-phase system Co—Cu—Cr.

12. The cemented carbide body of claim 11, wherein the copper proportion in the cemented carbide body lies in the range of 1.2 to 3.6% by weight.

13. The cemented carbide body of claim 11, wherein the copper proportion in the metallic binder lies in the range of 8.4 to 24.5% by weight, based on the nominal overall weight of the components Co, Cu and Cr of the binder.

14. The cemented carbide body of claim 1, wherein the chromium proportion in the cemented carbide body lies below the solubility limit of Cr in the 3-phase system Co—Cu—Cr.

15. The cemented carbide body of claim 14, wherein the chromium proportion in the cemented carbide body lies in the range of 0.4 to 0.8% by weight.

16. The cemented carbide body of claim 14, wherein the chromium proportion in the metallic binder lies in the range of 6.0 to 8.0% by weight, based on the nominal overall weight of the components Co, Cu and Cr of the binder.

17. The cemented carbide body of claim 1, wherein the chromium proportion in the cemented carbide body lies above the solubility limit of Cr in the 3-phase system Co—Cu—Cr.

18. The cemented carbide body of claim 15, wherein the chromium proportion in the sintered cemented carbide body lies in the range of 1.4 to 1.9% by weight.

19. The cemented carbide body of claim 14, wherein the chromium proportion in the metallic binder lies in the range of 9.7 to 14.4% by weight, based on the nominal overall weight of the components Co, Cu and Cr of the binder.

20. The cemented carbide body of claim 1, wherein the body has a copper gradient with a copper content which decreases from the core to the outer shell.

21. The cemented carbide body of claim 1, wherein the body contains as hard material, in addition to tungsten carbide, one or more compounds which are selected from the carbides, nitrides, carbonitrides, including the mixtures and solid solutions thereof, of the metals titanium, zirconium, hafnium, niobium, tantalum, vanadium and molybdenum.

22. The cemented carbide body of claim 1, wherein the body has at least one cutting edge, which is formed at the point where a flank and a rake face meet.

23. The cemented carbide body of claim 1 having at least one wear-resistant coating applied to the body.

24. A method comprising cutting metal or metal alloy using a sintered cemented carbide body comprising tungsten carbide and a metallic binder which contains cobalt, chromium and copper, wherein cobalt is present in a proportion of 7.0 to 14.0% by weight, copper is present in a proportion of 0.05 to 3.8% by weight and chromium is present in a proportion of 0.2 to 1.9% by weight, in each case based on the overall weight of the sintered cemented carbide body.

25. The method of claim 24, wherein the cemented carbide body is used for cutting titanium or titanium alloys.

26. The method of claim 25, wherein the copper portion is from 0.2 to 1.2% by weight, based on the overall weight of the cemented carbide body.

27. The method of claim 25, wherein the copper proportion in the cemented carbide body lies below the solubility limit of copper at room temperature.

28. The method of claim 25, wherein the copper portion in the metallic binder is at most approximately 10% by weight, based on the nominal overall weight of the components Co, Cu and Cr of the cemented carbide body.

29. The method of claim 24, wherein the cemented carbide body is used for cutting cast iron.

30. The method of claim 29, wherein the copper portion is from 0.7 to 3.6% by weight, based on the overall weight of the cemented carbide body.

31. The method of claim 30, wherein the copper proportion is from 2.4 to 2.6% by weight and the chromium proportion is from 0.8 to 1.3% by weight.

32. The method of claim 30, wherein the copper proportion is from 0.7 to 1.4% by weight and the chromium proportion is from 1.4 to 1.9% by weight.

33. The method of claim 24, wherein the cemented carbide body is used for cutting nodular cast iron.

34. The method of claim 31, wherein the copper portion is 0.8 to 3.6% by weight, based on the overall weight of the cemented carbide body.

35. The method of claim 33, wherein the chromium proportion is from 0.8 to 1.9% by weight.

36. The method of claim 24, wherein cutting comprises milling metals or metal alloys.

37. A process for producing a sintered cemented carbide body comprising providing a pulverulent mixture comprising tungsten carbide, Co, Cu and compounds of Cr; forming the mixture into a green compact; and sintering the green compact at a temperature of 1400 to 1450° C., wherein the sintered cemented carbide body contains cobalt in a proportion of 7.0 to 14.0% by weight, copper in a proportion of 0.05 to 3.8% by weight and chromium in a proportion of 0.2 to 1.9% by weight, in each case based on the overall mass of the cemented carbide body.
